(19) United States
(12) Patent Application Publication
(10) Pub. No.: US 2016/0171111 A1
(43) Pub. Date: Jun. 16, 2016

(54) METHOD AND SYSTEM TO DETECT USE CASES IN DOCUMENTS FOR PROVIDING STRUCTURED TEXT OBJECTS

(71) Applicant: Yahoo! Inc., Sunnyvale, CA (US)

(72) Inventors: Reiner Kraft, Gilroy, CA (US); Ergin Elmacioglu, Sunnyvale, CA (US); Viraj Chavan, Sunnyvale, CA (US)

(21) Appl. No.: 14/572,339

(22) Filed: Dec. 16, 2014

(51) Int. Cl. G06F 17/30

(52) U.S. Cl. CPC G06F 17/30867

(57) ABSTRACT

The present teaching relates to providing structured text. In one example, a document is obtained. One or more keywords are identified in the document. One or more topics are determined based on the one or more keywords. Each of the one or more topics is related to at least one of the one or more keywords residing in one or more portions of the document. A snippet is generated for each of the portions associated with a corresponding topic based on content in the portion of the document.

### BACKGROUND

1. Technical Field

The present teaching relates to methods, systems, and programming for Internet services. Particularly, the present teaching is directed to methods, systems, and programming for providing a search result.

2. Discussion of Technical Background

The advancement in the Internet has made it possible to make a tremendous amount of information accessible to users located anywhere in the world. A user may search for information on the Internet with help from a search engine, which can generate a search result in response to a search query from the user. The search engine may provide snippets along with a search result. A snippet typically comprises a short excerpt of text from a web page of the search result and is displayed with a link to the web page.

Conventional approaches for providing a snippet focus on generating the snippet after receiving a query from a user. For example, a conventional snippet in a search result is excerpted from a web page matching the query. This excerpting process can be time consuming if the query is long and/or the web page includes lots of content. In addition, the snippet generated in this conventional manner may not satisfy the user's real intent when the query includes some ambiguous terms.

Therefore, there is a need to develop techniques to provide a snippet to overcome the above drawbacks.

### SUMMARY

The present teaching relates to methods, systems, and programming for Internet services. Particularly, the present teaching is directed to methods, systems, and programming for providing a snippet.

In one example, a method, implemented on a machine having at least one processor, storage, and a communication platform connected to a network for generating a snippet, is disclosed. A document is obtained. One or more keywords are identified in the document. One or more topics are determined based on the one or more keywords. Each of the one or more topics is related to at least one of the one or more keywords residing in one or more portions of the document. A snippet is generated for each of the portions associated with a corresponding topic based on content in the portion of the document.

In another example, a method, implemented on a machine having at least one processor, storage, and a communication platform connected to a network for providing a search result, is disclosed. A query is received. One or more keywords are identified from the query. One or more topics associated with the query are determined based on the one or more keywords. One or more snippets are retrieved based on the one or more topics. Each of the snippets corresponds to a portion of a corresponding document that is related to a topic associated with the snippet. The one or more snippets are provided in response to the query.

In yet another example, a system having at least one processor, storage, and a communication platform connected to a network for generating a snippet, is disclosed. The system comprises a document obtaining unit, an entity detector, a use case matching unit, and an indexed snippet generator. The document obtaining unit is configured for obtaining a document. The entity detector is configured for identifying one or more keywords in the document. The use case matching unit is configured for determining one or more topics based on the one or more keywords. Each of the one or more topics is related to at least one of the one or more keywords residing in one or more portions of the document. The indexed snippet generator is configured for generating a snippet for each of the portions associated with a corresponding topic based on content in the portion of the document.

In a different example, a system having at least one processor, storage, and a communication platform connected to a network for providing a search result, is disclosed. The system comprises a search request analyzer, an entity type identifier, a use case determiner, a snippet retriever, and a search result provider. The search request analyzer is configured for receiving a query. The entity type identifier is configured for identifying one or more keywords from the query. The use case determiner is configured for determining one or more topics associated with the query based on the one or more keywords. The snippet retriever is configured for retrieving one or more snippets based on the one or more topics. Each of the snippets corresponds to a portion of a corresponding document that is related to a topic associated with the snippet. The search result provider is configured for providing the one or more snippets in response to the query.

Other concepts relate to software for implementing the present teaching on providing a search result. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable tangible and non-transitory medium having information for generating a snippet is disclosed. The information, when read by the machine, causes the machine to perform the following: obtaining a document; identifying one or more keywords in the document; determining one or more topics based on the one or more keywords, wherein each of the one or more topics is related to at least one of the one or more keywords residing in one or more portions of the document; and generating a snippet for each of the portions associated with a corresponding topic based on content in the portion of the document.

In another example, a machine-readable tangible and non-transitory medium having information for providing a search result is disclosed. The information, when read by the machine, causes the machine to perform the following: receiving a query; identifying one or more keywords from the query; determining one or more topics associated with the query based on the one or more keywords; retrieving one or more snippets based on the one or more topics, wherein each of the snippets corresponds to a portion of a corresponding document that is related to a topic associated with the snippet; and providing the one or more snippets in response to the query.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for providing a search result with a snippet, according to an embodiment of the present teaching;

FIG. 2 is a high level depiction of another exemplary networked environment for providing a search result with a snippet, according to an embodiment of the present teaching;

FIG. 3 illustrates an exemplary diagram of an indexed snippet generation engine, according to an embodiment of the present teaching;

FIG. 4 is a flowchart of an exemplary process performed by an indexed snippet generation engine, according to an embodiment of the present teaching;

FIG. 5 illustrates an exemplary diagram of a use case matching unit, according to an embodiment of the present teaching;

FIG. 6 is a flowchart of an exemplary process performed by a use case matching unit, according to an embodiment of the present teaching;

FIG. 7 illustrates an exemplary diagram of an indexed snippet generator, according to an embodiment of the present teaching;

FIG. 8 is a flowchart of an exemplary process performed by an indexed snippet generator, according to an embodiment of the present teaching;

FIG. 9 illustrates an exemplary offline index table, where each snippet is associated with a use case and an entity type, according to an embodiment of the present teaching;

FIG. 10 illustrates an exemplary diagram of a search engine, according to an embodiment of the present teaching;

FIG. 11 is a flowchart of an exemplary process performed by a search engine, according to an embodiment of the present teaching;

FIG. 12 depicts the architecture of a mobile device which can be used to implement a specialized system incorporating the present teaching; and

FIG. 13 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of providing a snippet, realized as a specialized and networked system by utilizing one or more computing devices (e.g., mobile phone, personal computer, etc.) and network communications (wired or wireless). The method and system as disclosed herein aim at providing a snippet to a user in an effective and efficient manner.

After submitting a query to a search engine, a user may receive a search result including one or more content items. A content item in the search result may be presented with a snippet. The snippet in general may be a representative piece of information related to the content item. For example, the content item is a link to a web page, while the snippet is a text brief representative of the web page. The snippet can help the user to decide if the web page potentially includes content the user is interested in viewing before the user has to actually select the web page.

The system disclosed in the present teaching may pre-generate a snippet before receiving the query from the user. For any web page, the system can analyze its content to extract entities and other information that can help understanding the content. But a user may be interested in specific localized information within the web page and only interact with those portions that he/she is more interested in, which in most cases, may be a subset of all the content on the page. The system can determine these “use cases” that can represent topics interesting to a user and reflect the intent when/if the user interacts with the page. In present disclosure, “use case” and “topic” will be used interchangeably. The system can detect a use case by comparing an extracted entity with use cases, based on contextual information of the entity in the web page. For example, a use case about movie show times is detected when an entity “show times” is extracted with contextual information about a movie name, a date, and/or a place.

Each use case may be associated with one or more portions of the web page. For example, a document on the web page may include multiple portions related to a same topic. For each portion, the system can generate a snippet following a structure associated with the corresponding use case. For example, a movie show times use case may be associated with a structure including parameters “Date, Time, Ratings, Cast List,” such that the snippet generated for the movie show times use case will follow this structure. Accordingly, the system can automatically extract information from the web page that contains the associated parameters to solve use cases as structured objects, e.g. snippets. The same process may be applied to detect use cases and generate snippets from any document, including a text, audio, or video file, or any other content items.

The snippet generation process can be performed without any input from a user. Each snippet generated in this process may be associated with a use case and an entity type. As such, the system can build up an offline index for records in a database, where each record includes a list of elements like a URL (uniform resource locator) of the web page, a use case, an entity type, one or more parameters in an associated structure, a snippet, etc. Based on this index, the system can quickly retrieve an element from a record given information about one or more other elements in the record. For example, once the system receives a query that matches an entity type and a use case of a record, the system may immediately retrieve and provide a corresponding snippet in response to the query. This provides a template based mechanism for the system to quickly populate a search result with snippets in a standardized way for easy information consumption. In present disclosure, “snippet” and “structured text object” will be used interchangeably to indicate any text object to be displayed in a structured way.

By directly retrieving snippets previously generated and stored in a database, the system offers an efficient way to help the user to filter through the search result in a shorter amount of time. By utilizing contextual information to confirm a use case in a web page, the system can accurately predict or estimate intent of a user whose query matches the use case. In addition, the system may pre-determine a confidence score for each snippet in the database to represent a confidence of predicting user intent with the snippet. A search result provided by the system may include only snippets with confidence scores higher than a predetermined threshold.

The present disclosure provides a use case indexed snippet database. Then the downstream system/platform can determine how to use this new dimension of data about content. A search engine is a naturally fit system for this, as a query can directly be answered from this database, provided that the use case for the query itself can be identified. Unlike a text blob for usual snippets, the use case extracted from the database can be displayed in a structured way as it has structured data that can satisfy the use case. For example, “divergent showtimes” may just be presented with only “date/time/movie theater names” in a fancy search module, rather than the actual text snippet from the local content in a document where the use case is detected in.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

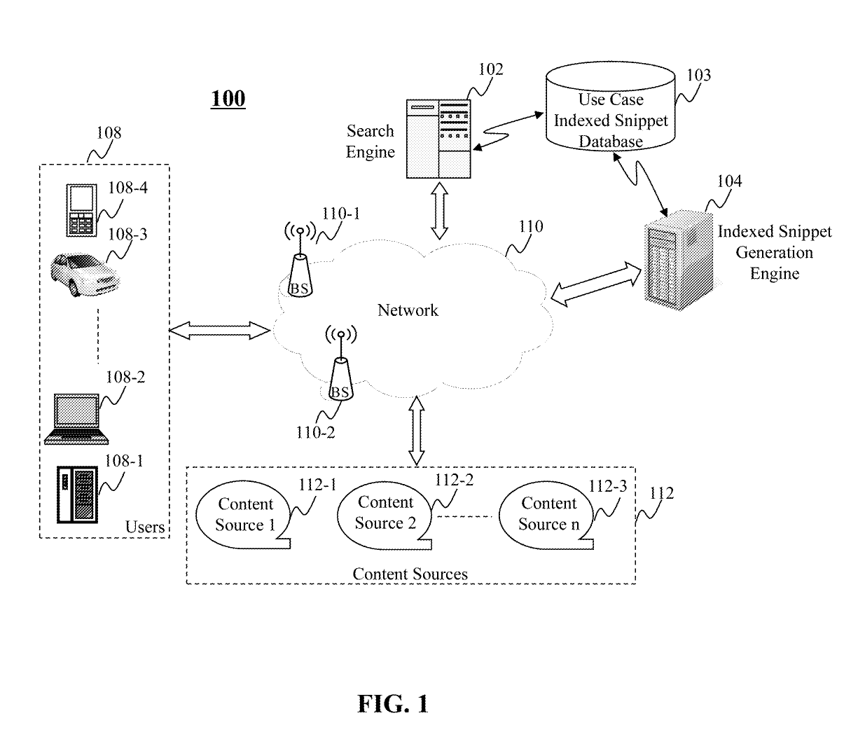

FIG. 1 is a high level depiction of an exemplary networked environment 100 for providing a search result with a snippet, according to an embodiment of the present teaching. In FIG. 1, the exemplary networked environment 100 includes a search engine 102, a use case indexed snippet database 103, an indexed snippet generation engine 104, one or more users 108, a network 110, and content sources 112. The network 110 may be a single network or a combination of different networks. For example, the network 110 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 110 may be an online advertising network or ad network that is a company connecting advertisers to web sites that want to host advertisements. The network 110 may also include various network access points, e.g., wired or wireless access points such as base stations or Internet exchange points 110-1 . . . 110-2, through which a data source may connect to the network 110 in order to transmit information via the network 110.

Users 108 may be of different types such as users connected to the network 110 via desktop computers 108-1, laptop computers 108-2, a built-in device in a motor vehicle 108-3, or a mobile device 108-4. A user 108 may send a search request to the search engine 102 via the network 110 and receive a search result from the search engine 102. The search result may be on a web page and may include links to documents relevant to the search request and/or one or more snippets associated with the documents.

The indexed snippet generation engine 104 may generate snippets and store them in the use case indexed snippet database 103. The indexed snippet generation engine 104 may access a plurality of documents, either on web pages or in databases. For each document, the indexed snippet generation engine 104 may detect some keywords which may be entities or tokens. For example, a document may include an entity “MOVIE” and a token “show times.” Based on the keywords, the indexed snippet generation engine 104 may determine one or more topics each related to some keywords residing in one or more portions of the document. Based on each topic, the indexed snippet generation engine 104 can identify the one or more corresponding portions. For each portion, the indexed snippet generation engine 104 can generate a snippet to represent the portion. Each generated snippet is associated with a corresponding portion of a corresponding document, and a corresponding topic. The indexed snippet generation engine 104 may build up an offline index for each snippet, e.g. based on the corresponding topic and/or other information associated with the snippet. The other information may include but not limited to: the keywords, parameters related to a structure of the snippet, representation of the corresponding portion, a URL associated with the document, a confidence score, etc. The information may be stored in the use case indexed snippet database 103, in association with the snippets.

The use case indexed snippet database 103 may store snippets generated by the indexed snippet generation engine 104, together with information associated with the snippets. The indexed snippet generation engine 104 may also retrieve and update some existing snippets in the use case indexed snippet database 103 if needed. The search engine 102 may directly retrieve snippets stored in the use case indexed snippet database 103, e.g. based on a search request from the user 108, and provide the snippets to the user.

The content sources 112 include multiple content sources 112-1, 112-2 . . . 112-3, such as vertical content sources. A content source 112 may correspond to a website hosted by an entity, whether an individual, a business, or an organization such as USPTO.gov, a content provider such as cnn.com and Yahoo.com, a social network website such as Facebook.com, or a content feed source such as tweeter or blogs. The search engine 102 and the indexed snippet generation engine 104 may access information from any of the content sources 112-1, 112-2 . . . 112-3.

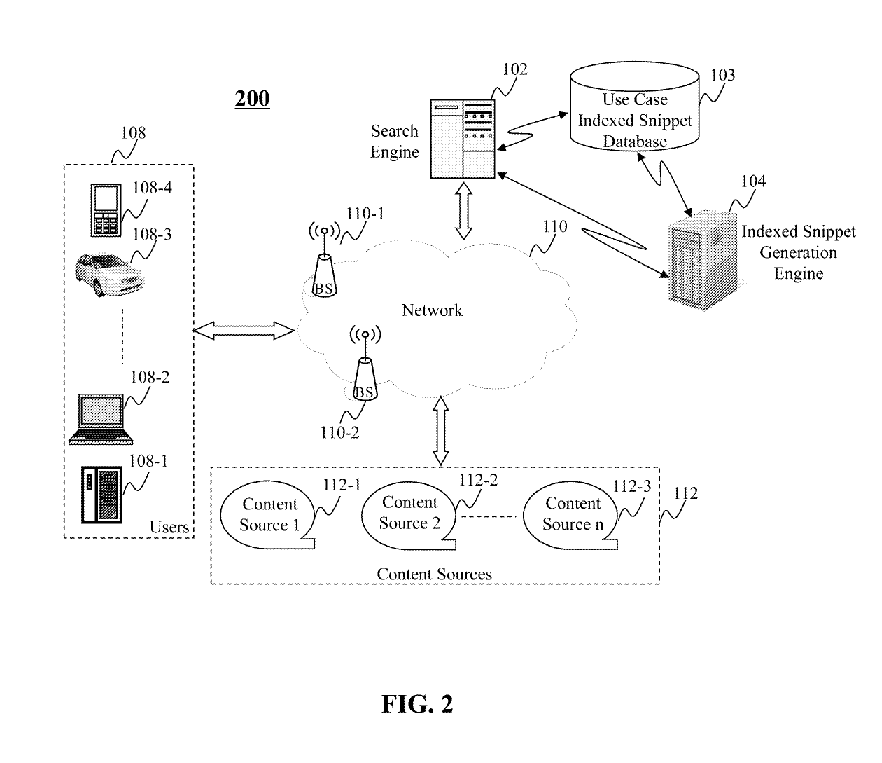

FIG. 2 is a high level depiction of another exemplary networked environment 200 for providing a search result with a snippet, according to an embodiment of the present teaching. The exemplary networked environment 200 in this embodiment is similar to the exemplary networked environment 100 in FIG. 1, except that the indexed snippet generation engine 104 serves as a backend system of the search engine 102.

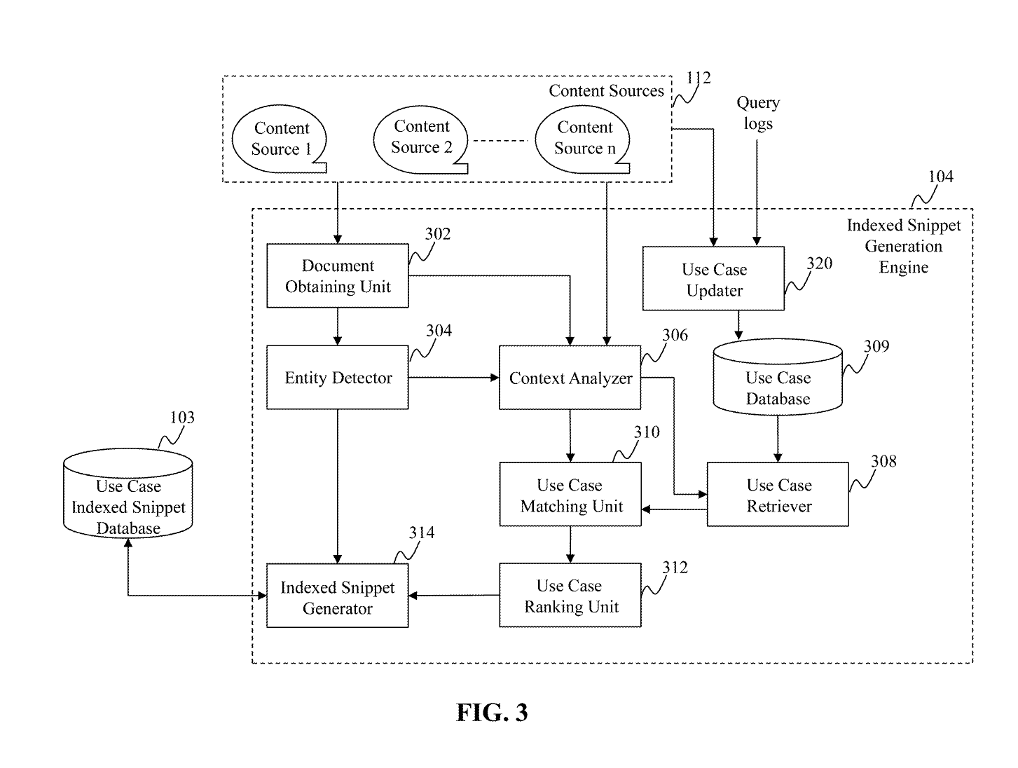

FIG. 3 illustrates an exemplary diagram of the indexed snippet generation engine 104, according to an embodiment of the present teaching. The indexed snippet generation engine 104 in this example includes a document obtaining unit 302, an entity detector 304, a context analyzer 306, a use case retriever 308, a use case database 309, a use case matching unit 310, a use case ranking unit 312, an indexed snippet generator 314, and a use case updater 320.

The document obtaining unit 302 in this example obtains a document from the content sources 112. The document may be in form of a file of text, image, audio, video, HTML, etc. The document obtaining unit 302 may keep obtaining documents and send each document to the entity detector 304 for entity detection and the context analyzer 306 for context analysis related to the entity.

The entity detector 304 in this example detects keywords from the document. The keyword may be an entity name, e.g. a movie name, a token like “show time” or “production cost”, or any word or phrase. Each keyword may be detected based on an analysis with a keyword database. In practice, the entity detector 304 may cooperate with a content analysis platform (CAP) to analyze the document and obtain relevant keywords or entities with associated metadata. At the end of the CAP analysis process, the entity detector 304 may obtain a list of entities for each of which CAP returns its position, its textual description, an optional Wikipedia URI (uniform resource identifier), a relevance score, and/or entity type(s) referring to CAP knowledgebase taxonomy. Each entity has a corresponding entity type, and one entity type may correspond to multiple entities. For example, entities “Titanic”, “Star Wars,” and “Avatar” all correspond to the entity type “InTheaterMovie.”

The textual description of such entities that CAP detects may be ambiguous, e.g., “apple.” In that case, the entity detector 304 may only consider entities that CAP resolves to a Wikipedia URI, e.g., “http://en.wikipedia.org/wiki/Apple_Inc.” Then the entity detector 304 can use a mapping table from Wikipedia, or a normalization step, to extract the full entity name and/or possible aliases for the entity, like “Apple Computer,” “Apple Inc.,” “Apple,” etc.

The context analyzer 306 in this example receives the detected keywords from the entity detector 304 and receives the associated documents from the document obtaining unit 302. For each detected keyword in a corresponding document, e.g. an entity, the context analyzer 306 may obtain the contextual keywords for the entity in the corresponding document, to further disambiguate the entity. In one example, the CAP may help the context analyzer 306 to check N words before and after the position of the entity, where N is a configurable number, e.g. 10. In another example, the CAP may consider a wider context window or use more sophisticated techniques such as extracting N sentences before and after the entity, taking into consideration the paragraph boundaries.

For an ambiguous entity in question, if other unambiguous entities are detected in the context of the entity, the context analyzer 306 may use those nearby entities and their metadata as additional contextual clues for the entity in question. For example, “Cupertino, Calif.” in the context of “Apple Inc” could be an important “place” typed entity. The context analyzer 306 may obtain the unambiguous entity and possible aliases, its entity type from CAP and/or from the Wikipedia categories, and the contextual keywords and entities from the document. Then, the context analyzer 306 may send the information to both the use case retriever 308 and the use case matching unit 310 for determining if there is any use case that fits well to the entity and its context in that document, and if so, which one is the most coherent.

The use case retriever 308 in this example retrieves use cases from the use case database 309. A use case is a description that can represent a topic of interest and can reflect intent of a user who is interested in the topic. A use case may include the following information that identifies the use case: query patterns, context terms, and a category. A query pattern may be a pattern of query that is associated with the use case. For example, a query like “Star Wars showtimes” matches a query pattern of “MOVIE_NAME showtimes” associated with a movie showtimes use case. The context terms of a use case defines some terms in the context of an entity at issue, to determine a match between the entity and the use case. The category may be an optional element in the use case. For example, the category may be a YCT (Yahoo common taxonomy) category. The category may further defines the use case, such that a match between the use case and an entity in a document is determined based on a match between the YCT category of the use case and a YCT category of the document returned from the CAP, if both are available.

In one embodiment, the use case retriever 308 may retrieve all use cases that have a query pattern including the entity detected at the entity detector 304 and analyzed by the context analyzer 306. For example, for an entity “MOVIE_NAME,” the use case retriever 308 may retrieve a use case from the use case database 309 if the use case has a query pattern “MOVIE_NAME showtimes,” “MOVIE_NAME production cost,” or “MOVIE_NAME box office.”

In another embodiment, the use case retriever 308 may retrieve use cases based on the category. If the document obtained at the document obtaining unit 302 has a YCT category, e.g. based on the CAP analysis, the use case retriever 308 may retrieve all use cases that have the same YCT category from the use case database 309. It can be understood by one skilled in the art that the use case retriever 308 may retrieve use cases based on other criteria with respect to an entity and/or a corresponding document.

The use case retriever 308 may send the retrieved use cases to the use case matching unit 310. The use case matching unit 310 in this example matches the use cases retrieved by the use case retriever 308 with the keywords or entities received from the context analyzer 306. The use case matching unit 310 may pull information about each use case and each entity. For each entity in a document, the use case matching unit 310 may measure how similar each use case is to the entity and its context in the document in various dimensions. In one dimension, the use case matching unit 310 may measure a similarity between the YCT category of the use case and the YCT category of the document returned from CAP, if both are available. In another dimension, the use case matching unit 310 may tokenize context of the entity in the document into a vector, and measure a similarity between that vector and a context terms vector of the use case. In a different dimension, the use case matching unit 310 may measure a similarity between the query pattern of the use case and the entity with its contextual information. For example, a query pattern “MOVIE_NAME showtimes in PLACE_NAME” is satisfied in a loose mode in the context of the entity MOVIE_NAME, if the term “showtimes” is detected in the context of this entity and if PLACE_NAME is detected by CAP as a place name in the context of the entity.

For each of the above dimensions, the use case matching unit 310 may generate a score and/or Boolean flags representing a degree of similarity. The use case matching unit 310 may apply custom rules to determine if a use case is a good match to the entity in the document. For instance, the use case matching unit 310 may determine the use case is a good match for the entity in the context in the document, if the following rules are satisfied. First, if both the document and the use case have a YCT category, they must be the same. Second, there is at least one query pattern of the use case that matches the context of the entity. Third, a degree of similarity between the context terms of the use case and the context vector of the entity is greater than a predetermined threshold.

The use case matching unit 310 may use different rule sets to determine the strength of a match, e.g. “high”, “medium”, “low”, or alternatively train a classifier that can output a score for a use case match. This can later be used by the use case ranking unit 312 to output a ranked list of all uses cases that match the entity. Furthermore, more advanced unsupervised learning methodologies can be applied at the use case matching unit 310 as well.

Therefore, for an entity with contextual information, the use case matching unit 310 can match it with a larger set of use cases to determine whether there is a match. The use case matching unit 310 may determine one or more matched use cases for each entity, and generate a score for each matched use case based on a degree of the matching. In one example, the use case matching unit 310 may output an enhanced vector of use cases each having the following information: entity properly resolved as anchor for the use case, an entity type related to the entity, start and end of context of the entity, and/or score(s) representing a probability/degree of match between the use case and the entity.

This approach can improve any content understanding system by adding a new dimension of annotations that are specific to local content. The new annotations can therefore improve any downstream system that serves content to users, e.g., Search, Personalization, etc. Upon understanding the user intent and interests, such systems may utilize these additional signals to categorize, rank and serve their content pool better and hence achieve better experience for users.

The use case matching unit 310 may send the matched use cases with their respective scores to the use case ranking unit 312. The use case ranking unit 312 in this example ranks the matched use cases based on their respective scores, for each entity. The use case ranking unit 312 then generates a ranked list of matched use cases for each entity and sends each ranked list to the indexed snippet generator 314.

The indexed snippet generator 314 in this example generates one or more snippets for each document obtained at the document obtaining unit 302. In one embodiment, a use case is associated with a desired list of parameters needed to be extracted for this use case. In this embodiment, the indexed snippet generator 314 may extract the list of parameters for each matched use case, either via the use case ranking unit 312, the use case retriever 308, or directly from the use case database 309. The list of parameters can define a structure for a snippet to be generated for the use case.

The indexed snippet generator 314 may generate a snippet for each use case based on the list of parameters. For example, the indexed snippet generator 314 may extract desired information from the corresponding document according to the list parameters, and form a snippet according to the structure determined by the list parameters. In one example, a use case may be associated with a plurality of portions in the corresponding document, e.g. when a keyword shows up multiple times in different portions of the document. In that case, the indexed snippet generator 314 may generate a snippet for each portion associated with the use case.

The indexed snippet generator 314 may generate an index for each snippet based on its associated use case and/or its associated portion. In general, the index can be built offline and can help locating a snippet with different elements associated with the snippet. The indexed snippet generator 314 may save the generated snippets with the index and associated information into the use case indexed snippet database 103.

In practice, a snippet in the use case indexed snippet database 103 may be located by an index table. The information in the use case indexed snippet database 103 may be organized as in the index table. The indexed snippet generator 314 may save information into the use case indexed snippet database 103 and/or retrieve information from the use case indexed snippet database 103 based on the index table.

The use case updater 320 in this example may update the use case database 309 periodically, from time to time, or upon request. For example, based on a new taxonomy in a content source 112, or based on information from query logs, the use case updater 320 may detect new use cases. The use case updater 320 can store the newly detected use cases into the use case database 309 following same structure as existing use cases in the use case database 309.

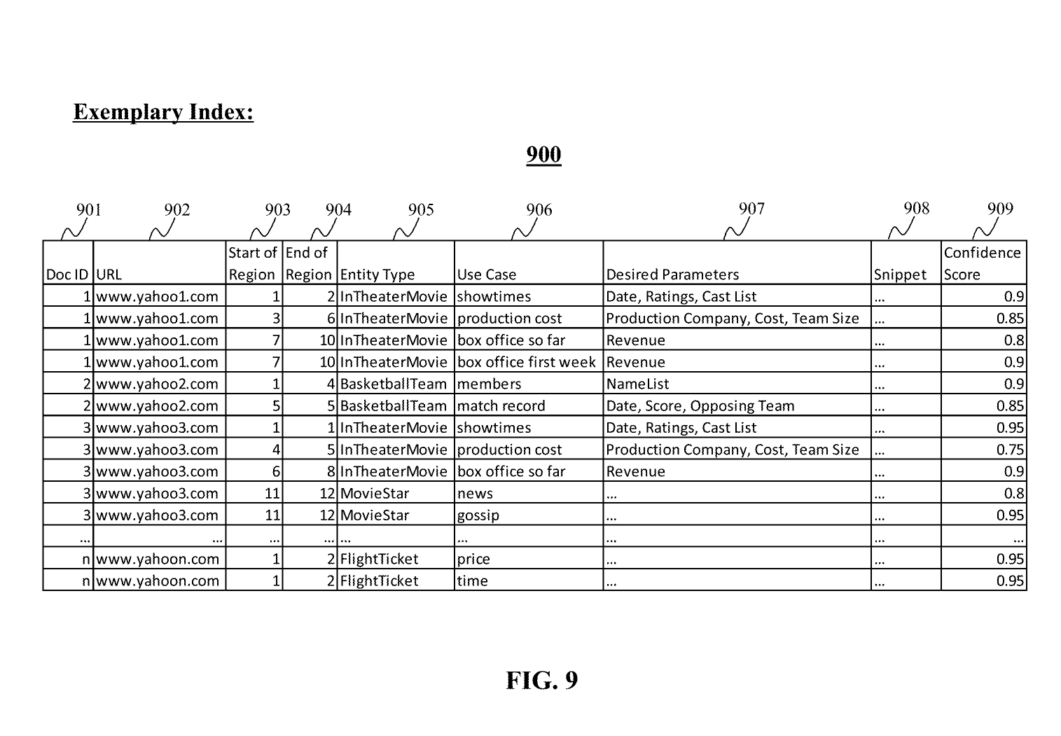

FIG. 9 illustrates an exemplary offline index table 900, according to an embodiment of the present teaching. The offline index table 900 can comprise various columns, including but not limited to: a Doc ID column 901, a URL column 902, a Start of Region column 903, an End of Region column 904, an Entity Type column 905, a Use Case column 906, a Desired Parameters column 907, a Snippet column 908, and a Confidence Score column 909.

As shown in FIG. 9, the Doc ID column 901 may indicate an identity of a document, e.g. 1, 2, 3 . . . n. It can be understood that other symbols can be used to identify different documents in the Doc ID column 901. The URL column 902 may indicate a URL associated with the document, e.g. www.yahoo1.com. The Start of Region column 903 and the End of Region column 904 may indicate a starting point and an ending point of a portion of the document, respectively. In this example, the starting point and the ending point are represented by paragraphs of the document. For example, the first row in the table corresponds to a portion/region covering the first and second paragraphs of the document. It can be understood that a portion of a document can be indicated in other ways, e.g., by specifying a first offset from the start of the document as the starting point in the Start of Region column 903 and specifying a second offset from the start of the document as the ending point in the End of Region column 904. The offset may be counted in terms of words, phrases, bytes, or in any other proper ways.

The Entity Type column 905 in this table indicates an entity type associated with the corresponding portion in the same row. The Use Case column 906 may indicate a use case associated with the entity type and the portion. For example, in the first row of the table, the first and second paragraphs of the document are associated with an entity type “InTheaterMovie” and a use case “showtimes,” which means the first two paragraphs include a topic about show times of some movie in theater. As shown in FIG. 9, a same portion of a document may correspond to different use cases. For example, paragraphs 7 to 10 of the document 1 are associated with both a use case about “box office so far” and a use case about “box office first week.” In one example, two portions corresponding to two use cases may have some overlap in the same document.

Each element in the Desired Parameters column 907 includes a list of desired parameters related to the corresponding use case and the entity type in the same row. The parameters indicate information desired for generating a snippet representative of the corresponding portion. For example, in the first row, a representative snippet needs to include information about “Date, Ratings, Cast List” of a movie to satisfy people's desire about the show times of the movie. For example, in the second row, a representative snippet needs to include information about “Production Company, Cost, Team Size” of a movie to satisfy people's desire about the production cost of the movie.

The Snippet column 908 includes the snippets each generated in a structure following the corresponding desired parameters. For example, a snippet associated with entity type Titanic and showtimes use case may include a description like: Titanic will be shown on Dec. 20-31, 1997, with a Rating of 4.8/5, and its cast list includes Leonardo DiCaprio, Kate Winslet, etc. It can be understood by one skilled in the art that more parameters may be added to the Desired Parameters column 907, such that a corresponding snippet may include more parameters. For example, the show time use case may also be associated with parameters like theater name showing the movie, schedule of the movie in the theater, etc.

The Confidence Score column 909 in this table shows a confidence score for each snippet in the Snippet column 908. The confidence score represent a degree of confidence of predicting user intent or satisfying user's desire with the snippet. The confidence score in this table are numbers between 0 and 1, where 1 means most confident and 0 means least confident or no confidence. For example, in the first row, the confidence score is 0.9, which means a high confidence for the snippet to reflect the topic of interest about the corresponding use case InTheaterMovie showtimes. This may be because the corresponding portion of the document 1 includes enough on point information according to the desired parameters. In another example, in the eighth row, the confidence score is 0.75, which means a lower confidence for the snippet to reflect the topic of interest about the corresponding use case InTheaterMovie production cost. This may be because the corresponding portion of the document 3 does not include enough on point information according to the desired parameters. For example, the portion may include information about the “Production Company” and “Cost”, but no information about the “Team Size.” It can be understood that the confidence score may also be represented in other ways, e.g. by a percentage number, by a range of number from 0 to 100, etc.

With the index table 900, the system may retrieve any element based on its corresponding elements in the same row and/or its corresponding elements in the same column. For example, the system may retrieve a corresponding URL www.yahoo1.com, given the entity type “InTheaterMovie” and the use case “box office first week.” In another example, the system can retrieve multiple URLs, e.g. both www.yahoo1.com and www.yahoo3.com, given the entity type “InTheaterMovie” and the use case “production cost.”

The system may also retrieve a corresponding snippet based on a given entity type and/or a given use case. For example, a user may show interest about “match record” of “Los Angeles Lakers,” e.g. by submitting a query including those keywords. Then the system may directly retrieve information in the sixth row of the table 900, including but not limited to the document ID 2, the URL www.yahoo2.com, the starting and ending paragraphs (which are both the fifth paragraph here), the pre-generated snippet, and the confidence score associated with snippet. The system can provide the retrieved information to the user. Particularly, the system may provide the retrieved snippet for the user to quickly check whether it satisfies his/her desire about the “match record” of “Los Angeles Lakers.”

When the system identifies multiple snippets based on a query from a user, the system may retrieve only the snippets with a confidence score higher than a predetermined threshold or retrieve the snippets one by one according to a descending order of their respective confidence scores until a predetermined number is reached. The system may provide multiple snippets related to the query in a descending order of their respective confidence scores.

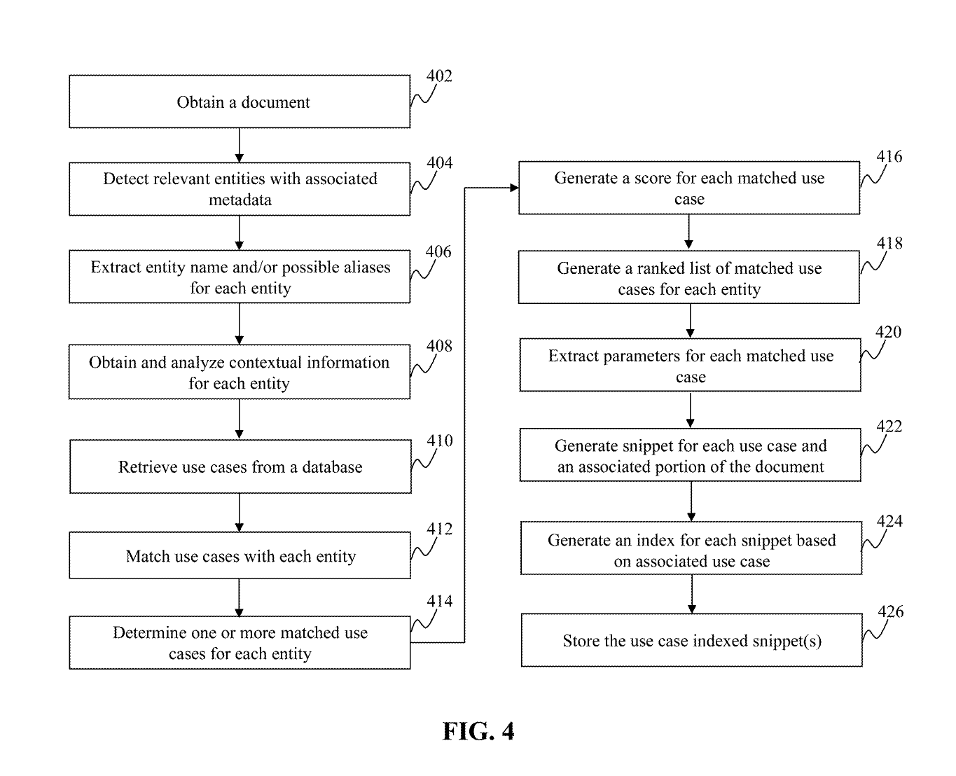

FIG. 4 is a flowchart of an exemplary process performed by the indexed snippet generation engine 104, according to an embodiment of the present teaching. At 402, a document is obtained. At 404, relevant entities or keywords are detected from the document with associated metadata. At 406, entity name and/or possible aliases are extracted for each entity. At 408, contextual information for each entity is obtained and analyzed. At 410, use cases are retrieved from a database, e.g., based on each entity. At 412, use cases are matched with each entity. At 414, one or more matched use cases are determined for each entity, e.g. based on the matching at 412.

At 416, a score is generated for each matched use case. The score may represent a degree of matching between each use case and its associated entity. The score may be any number or symbol within a specified range. At 418, a ranked list of matched use cases is generated for each entity, e.g. based on their respective scores. At 420, desired parameters are extracted for each matched use case. This may include extracting missing parameters/information of the corresponding use case from a snippet/text block, e.g. in a document. At 422, a snippet is generated for each use case and/or each associated portion of the document. At 424, an index is generated for each snippet, e.g. based on its associated use case and other associated information. At 426, each generated snippet is stored with the index.

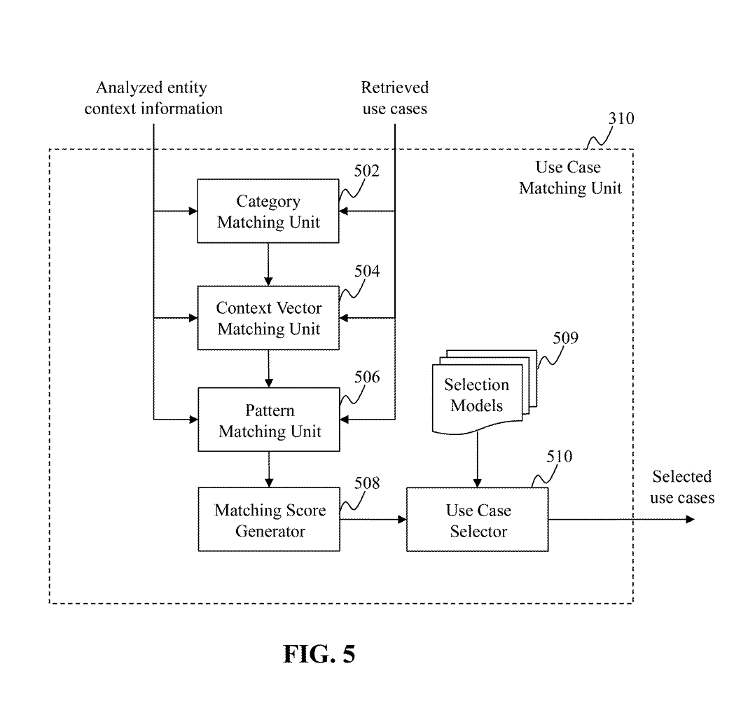

FIG. 5 illustrates an exemplary diagram of the use case matching unit 310, according to an embodiment of the present teaching. The use case matching unit 310 in this example includes a category matching unit 502, a context vector matching unit 504, a pattern matching unit 506, a matching score generator 508, one or more selection models 509, and a use case selector 510.

The category matching unit 502 in this example receives both analyzed entity context information and information about the retrieved use cases. As discussed before, each use case may include information about a category, and CAP analysis can determine a category for an entity. The category matching unit 502 may measure a similarity between the categories of the use case and the entity. In one example, their categories need to be a same type of category, e.g. the YCT category. The category matching unit 502 may generate a first matching score regarding a degree of the similarity about category, for each matching performed at the category matching unit 502. The category matching unit 502 may send the first matching scores to the matching score generator 508 for determining matched use cases.

The context vector matching unit 504 in this example receives both analyzed entity context information and information about the retrieved use cases. The context vector matching unit 504 may tokenize context of the entity in the document into a vector. As discussed before, each use case may include a context terms vector representing context terms required to identify the use case. The context vector matching unit 504 may measure a similarity between that tokenized vector of the entity and the context terms vector of the use case. The context vector matching unit 504 may generate a second matching score regarding a degree of the similarity about context, for each matching performed at the context vector matching unit 504. The category matching unit 502 may send the second matching scores to the matching score generator 508 for determining matched use cases.

The pattern matching unit 506 in this example receives both analyzed entity context information and information about the retrieved use cases. The pattern matching unit 506 may measure a similarity between the query pattern of the use case and the entity with its contextual information. For example, a query pattern “MOVIE_NAME showtimes in PLACE_NAME” is satisfied in a loose mode in the context of the entity MOVIE_NAME, if the term “showtimes” is detected in the context of this entity and if PLACE_NAME is detected by CAP as a place name in the context of the entity. The pattern matching unit 506 may generate a third matching score regarding a degree of the similarity about pattern, for each matching performed at the pattern matching unit 506. The pattern matching unit 506 may send the third matching scores to the matching score generator 508 for determining matched use cases.

The matching score generator 508 in this example generates a matching score for each use case regarding each entity. Based on the first, second, and third matching scores regarding different dimensions of matching, the matching score generator 508 may combine the three scores for each use case to generate the matching score with respect to an entity. In one example, the matching score may be a weighted combination of the three scores. In another example, the matching score generator 508 may following a rule to the three scores, e.g. if the first matching score is larger than 90%, taking the average of the second and the third scores; otherwise, assigning zero to the matching score. Other rules can be determined and applied based on different configuration. The matching score generator 508 may send the generated matching scores to the use case selector 510 for selecting use cases.

The use case selector 510 in this example determines matched use cases based on the matching scores generated at the matching score generator 508 and selects one or more matched use cases based on one of the selection models 509. A selection model may indicate how to select use cases based on their respective matching scores, regarding each entity or keyword. For example, according to one selection model, the use case selector 510 may only select use cases with a matching score higher than a predetermined threshold, regarding an entity. According to another selection model, the use case selector 510 may select top N use cases based on their respective matching score regarding an entity. In one embodiment, the use case selector 510 may send the selected use cases as matched use cases to the use case ranking unit 312 for ranking.

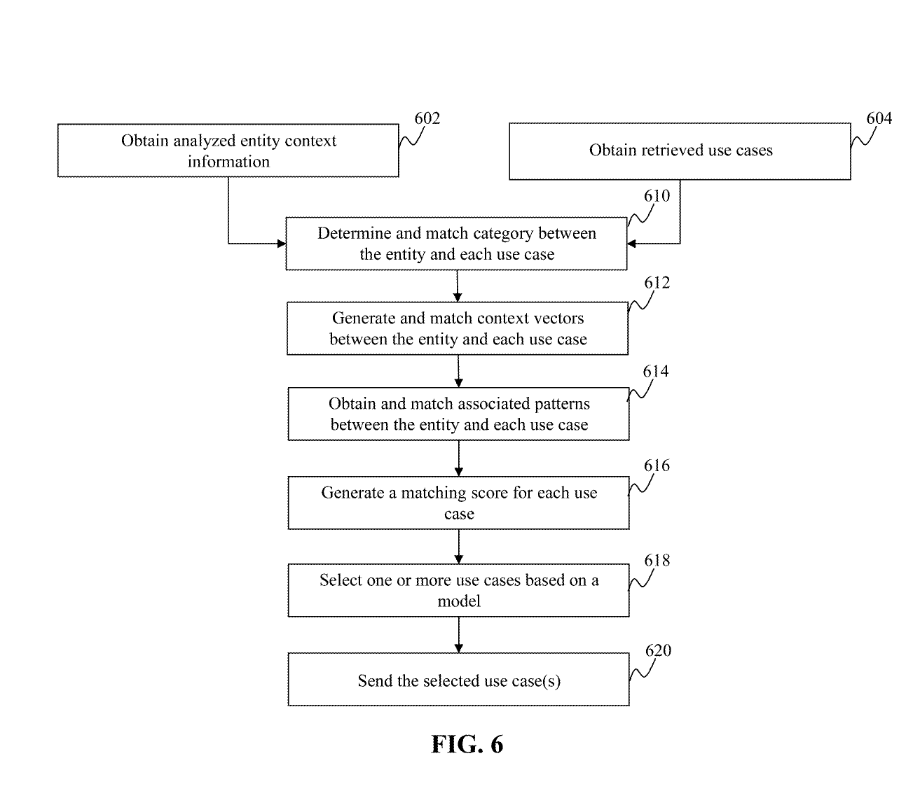

FIG. 6 is a flowchart of an exemplary process performed by the use case matching unit 310, according to an embodiment of the present teaching. At 602, analyzed entity context information is obtained. At 604, retrieved use cases are obtained. It can be understood that the steps 602 and 604 may be performed in parallel as shown in FIG. 6 or in serial.

At 610, the use case matching unit 310 performs determines categories of the entity and each use case and matches the categories. At 612, the use case matching unit 310 generates and matches context vectors between the entity and each use case. At 614, the use case matching unit 310 obtains and matches associated patterns between the entity and each use case. It can be understood that the steps 610-614 may be performed in serial as shown in FIG. 6 or in parallel.

At 616, a matching score is generated for each use case regarding an entity, e.g. based on at least one of the three matches performed in 610-614. The matching score may be any number or symbol within a specified range. At 618, one or more use cases are selected based on a model. At 620, the one or more selected use cases are sent.

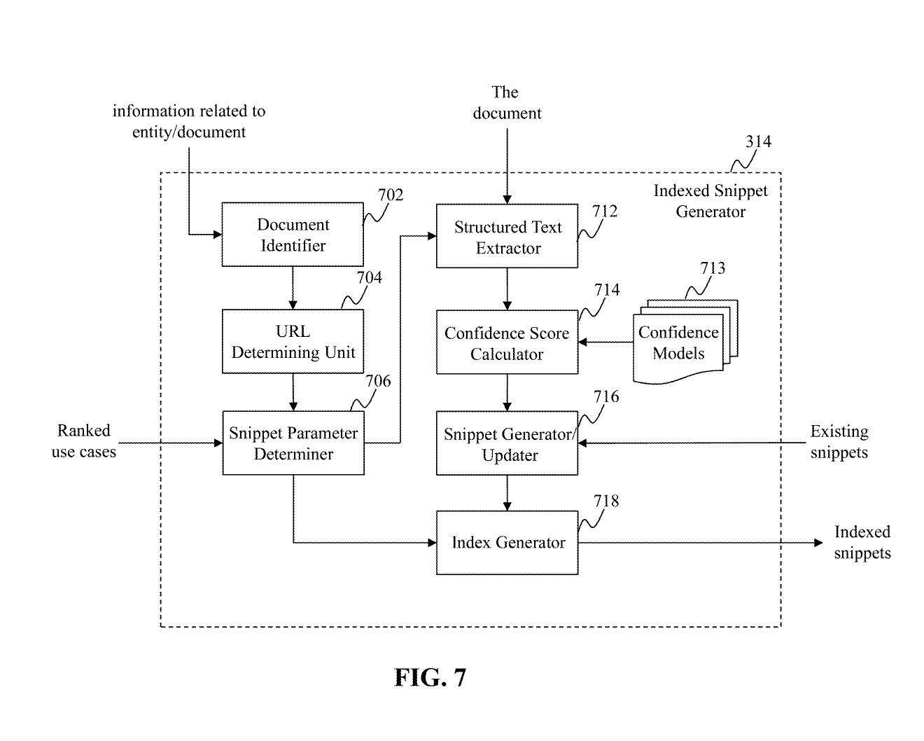

FIG. 7 illustrates an exemplary diagram of an indexed snippet generator 314, according to an embodiment of the present teaching. The indexed snippet generator 314 in this example includes a document identifier 702, a URL determining unit 704, a snippet parameter determiner 706, a structured text extractor 712, a confidence score calculator 714, one or more confidence models 713, a snippet generator/updater 716, and an index generator 718.

The document identifier 702 in this example obtains information related to entity and/or the corresponding document. Based on the information, the document identifier 702 can identify the document, e.g. to determine a Doc ID to be saved in the table shown in FIG. 9. The document identifier 702 may further identify a portion of the document including the entity. For example, the portion may be represented by a starting point and an ending point of the document, to be saved in the table shown in FIG. 9.

The URL determining unit 704 in this example can determine a URL associated with the document, e.g. based on an Internet service. The URL may be later saved in the same row as the Doc ID, as shown in FIG. 9.

The snippet parameter determiner 706 in this example may receive ranked use cases for each entity, e.g. from the use case ranking unit 312. For each use case, the snippet parameter determiner 706 may identify and retrieve one or more desired parameters associated with the use case. As discussed above, each use case is associated with some desired parameters indicating information needed to be extracted from the document for generating a representative snippet. The list of parameters may be later saved in the same row as the corresponding use case and a corresponding entity type that can be determined from the entity, as shown in FIG. 9. In one case, the list includes only one parameter.

The structured text extractor 712 in this example receives the parameters retrieved by the snippet parameter determiner 706 and extracts structured text items from the document. The structured text extractor 712 may access the document either via the entity detector 304 or through the URL determined by the URL determining unit 704. In practice, the structured text extractor 712 may have access to the actual content of the document, saved locally in some storage structure with the URL of a web page containing the document.

The structured text extractor 712 extracts information according the desired parameters. For example, according to desired parameters “Date, Score, Opposing Team” about a BaskerballTeam match record use case, the structured text extractor 712 may extract information about the team's previous matches, including the match dates, the match scores, and the opposing team's name. The text items extracted by the structured text extractor 712 may or may not follow a structure defined by the corresponding desired parameters. In one embodiment, an extracted text item following a desired structure is referred as a snippet.

The confidence score calculator 714 in this example calculates a confidence score for each snippet, e.g. based on one of the one or more confidence models 713. A confidence model may define how to calculate a confidence score. According to one confidence model, the confidence score calculator 714 may calculate a confidence score based on availability of information in the document, e.g. in the corresponding portion identified by the document identifier 702, regarding the desired parameters. According to another confidence model, the confidence score calculator 714 may calculate a confidence score based on authority of the document source with respect to the entity. For example, for entity “Apple Inc”, a snippet generated from www.apple.com may have a higher confidence score than another snippet generated from a personal blog, due to the authority of the official web site www.apple.com of Apple Inc. The confidence score calculator 714 may send the generated confidence scores to the snippet generator/updater 716.

The snippet generator/updater 716 in this example generates or updates a snippet. In one situation, the use case indexed snippet database 103 does not include a snippet corresponding to the same document, the same portion, the same entity, and/or the same use case. Then, the snippet generator/updater 716 may generate the snippet, based on the extracted text item by the structured text extractor 712. The snippet generator/updater 716 can make sure the generated snippet follows a desired structure defined based on the desired parameters determined by the snippet parameter determiner 706. In one example, the extracted text item already follows the desired structure, and the snippet generator/updater 716 may just confirm the structure to generate the snippet. In this situation, the snippet generator/updater 716 sends the generated snippets to the index generator 718 for generating an index for the snippet. The index generator 718 may generate an index for each snippet, based on some associated information of the snippet, e.g. the associated use case, the associated entity type, the associated portion of the corresponding document, etc. The index generator 718 may then store the indexed snippets with the associated information into the use case indexed snippet database 103.

In another situation, the use case indexed snippet database 103 already includes a snippet corresponding to the same document, the same portion, the same entity, and/or the same use case. This may happen if the document has been analyzed before but needs to be analyzed again with an updated model. In this situation, the snippet generator/updater 716 may retrieve the existing snippet from the use case indexed snippet database 103 and update the existing snippet with the snippet generated as discussed above.

By executing the above process for every URL or document, the system can create an offline index where every row has the URL, the use cases associated with the URL, and specific structured data (e.g. the snippets) from that URL that satisfies the associated use case(s). In practice, by making the use case data available to the CAP service, the entire extraction of the structured text objects (e.g. the snippets) can be done at the time of CAP processing of the web page or the document.

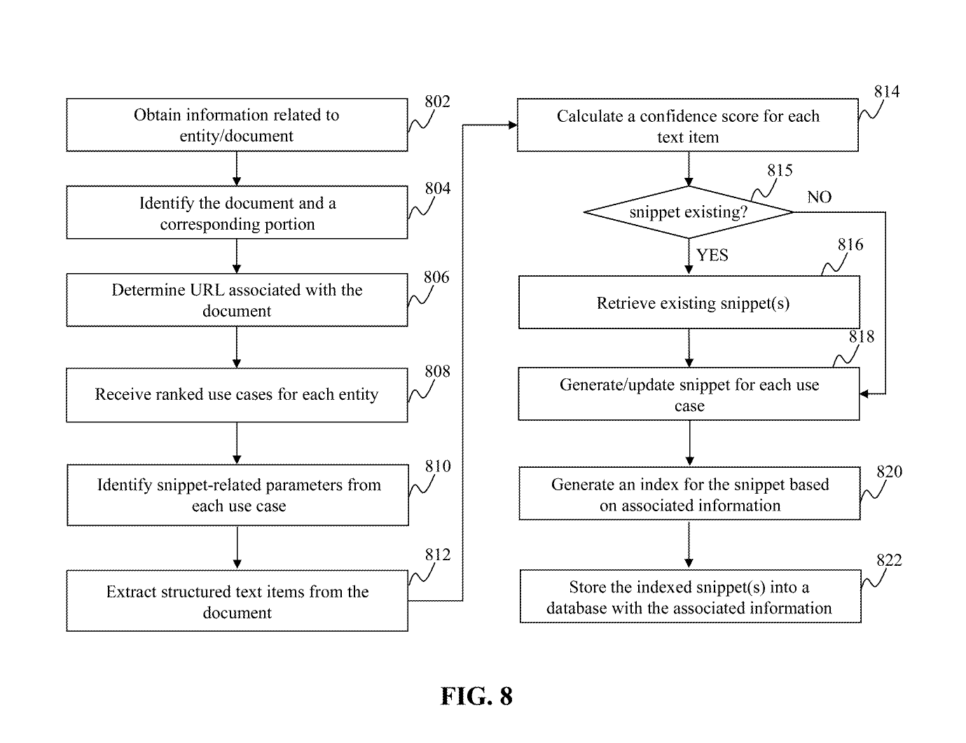

FIG. 8 is a flowchart of an exemplary process performed by the indexed snippet generator 314, according to an embodiment of the present teaching. At 802, information related to the entity and/or the document is obtained. At 804, the document and a corresponding portion in the document may be identified. At 806, a URL associated with the document is determined. At 808, ranked use cases are received for each entity. At 810, desired parameters related to snippets are identified from each use case. At 812, structured text items are extracted from the corresponding portion of the document. At 814, a confidence score is calculated for each text item. The confidence score may be any number or symbol within a specified range.

At 815, it is checked whether there is an existing snippet corresponding to each snippet to be generated. If so, the existing snippet is retrieved at 816 and updated with a newly generated snippet at 818. Otherwise, the process moves directly to 818 for generating the snippet, e.g. based on the extracted text item and desired parameters. At 820, an index is generated for the snippet based on some associated information, including but not limited to the use cases and/or the associated confidence score. At 822, the indexed snippets are stored in the use case indexed snippet database 103 with the associated information.

The use case may be a category following a User Centric Intent Taxonomy (UCIT). For example, the nomenclature of the parameter names associated with each use case form a part UCIT. By using the CAP system to detect the entities and by using a use case server with UCIT to map the entity to the desired parameters that are needed to be extracted, the system can extract structured text objects for display to the users. In practice, there may be some pre-computed table that maps the CAP entities to the UCIT entities, for CAP and UCIT to cooperate.

In one example, the user types in a query ‘MOVIE production cost’ (e.g., “Tom and Jerry production cost”). After applying the use case analysis on this query, the system can determine that this is the ‘ProductionCost’ use case for the “InTheaterMovie” entity type (within UCIT). The system can then query the offline index previously built up to retrieve URLs that have matches this particular use case and entity type. Then the system may return a search result including the structured text snippets to the user for review. The snippets may be text excerpts provided as answers to the production cost for that movie. The above process may be performed by the search engine 102 and/or the indexed snippet generation engine 104.

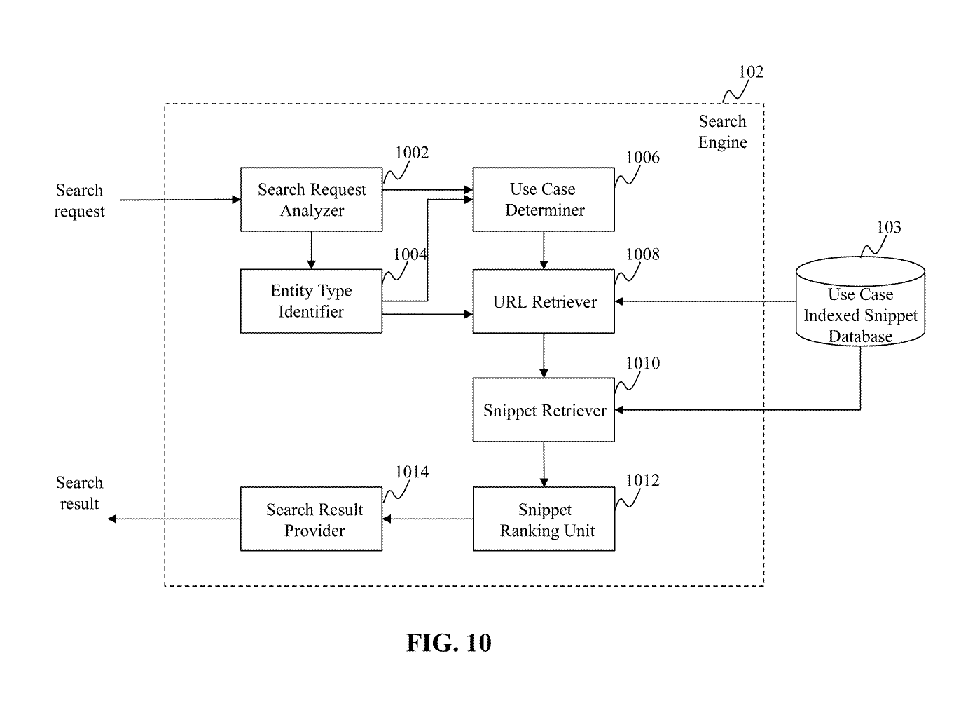

FIG. 10 illustrates an exemplary diagram of the search engine 102, according to an embodiment of the present teaching. The search engine 102 in this example includes a search request analyzer 1002, an entity type identifier 1004, a use case determiner 1006, a URL retriever 1008, a snippet retriever 1010, a snippet ranking unit 1012, and a search result provider 1014.

The search request analyzer 1002 in this example can receive a search request from a user and analyze the search request to extract information including e.g. a query and/or information about the user.

The entity type identifier 1004 in this example may parse the query to identify one or more keywords. A keyword may be an entity or a token. The entity type identifier 1004 can identify a type of an entity. For example, a query “Obama news” includes an entity “Obama” and a token “news.” The entity type identifier 1004 may determine that the entity “Obama” has an entity type of “Politician.” The entity type identifier 1004 may send the identified entities, entity types, and/or tokens to the use case determiner 1006 for determining a use case.

The use case determiner 1006 in this example determines one or more use cases based on the search request. In one embodiment, the use case determiner 1006 may determine a use case by matching the use case with the keywords detected from the search request or the query. As discussed before, a use case represents a topic of interest. Each use case may have a use case ID, which may be a category under a UCIT (user centric intent taxonomy) system. A use case is associated with one or more query terms and context terms. For example a “MOVIE showtimes” use case includes the entity “MOVIE” and the token “showtimes”. The presence of the entity and the token in close proximity in a given body of text strongly hints at the use case being applicable to the body of the text. As such, if the query from the user includes both the entity “MOVIE” and the token “showtimes” in close proximity, the use case determiner 1006 may determine the “MOVIE showtimes” use case to a matched use case for the query. It can be understood that one query may be matched to multiple use cases. For example, a query “Star Wars showtimes and box office” may be matched to several use cases: “MOVIE showtimes,” “MOVIE box office so far,” and “MOVIE box office first week.”

In another embodiment, the use case determiner 1006 may determine a use case based on the information about the user. For example, a search history of the user may indicate that he/she has searched about iPhone 6 release date, in accordance with a use case “SmartPhone release date.” Then if the user submits a query “6 release”, the use case determiner 1006 may determine a match between keywords in the query with the use case “SmartPhone release date.” Obviously in this case, the use case determiner 1006 may cooperate with a query suggestion module to provide the user “iPhone 6 release date” as a query suggestion. The system may also provide a search result with snippets, based on the query suggestion “iPhone 6 release date” directly, or providing the snippets based on the query suggestion with a higher priority than other snippets. In another example, the use case determiner 1006 may utilize the user's demographic information to predict or determine a use case. For example, the use case determiner 1006 may determine a query “iPhone” from a kid matches better with a use case “SmartPhone games” or “SmartPhone apps”; while a query “iPhone” from an adult user matches better with a use case “SmartPhone release date” or “SmartPhone prices”.

In a different example, the use case determiner 1006 may determine a use case based on an offline index table. As shown in the table 900 in FIG. 9, one or more use cases are associated with an entity type. Therefore, once the use case determiner 1006 receives an entity type from the entity type identifier 1004, the use case determiner 1006 may determine and retrieve one or more corresponding use cases based on the offline index table. For example, based on an entity type “FlightTicket,” the use case determiner 1006 may retrieve use cases “FlightTicket price” and “FlightTicket time,” e.g. from the use case indexed snippet database 103.

The URL retriever 1008 in this example can retrieve one or more URLs based on the search request. The URL retriever 1008 receives the entity type and use case associated with the search request, from the entity type identifier 1004 and the use case determiner 1006 respectively. Based on an offline index table, as shown in FIG. 9, the URL retriever 1008 may retrieve one or more corresponding URLs. For example, given the entity type “InTheaterMovie” and the use case “showtimes,” the URL retriever 1008 may determine URLs www.yahoo1.com and www.yahoo3.com in corresponding rows of the table 900 shown in FIG. 9. The URL retriever 1008 may retrieve the URL information from the use case indexed snippet database 103. In one example, an offline index table can have multiple copies stored in the search engine 102, the use case indexed snippet database 103, and the indexed snippet generation engine 104, such that both the search engine 102 and the use case indexed snippet database 103 may retrieve information from the use case indexed snippet database 103 and/or store information to the use case indexed snippet database 103.

The snippet retriever 1010 in this example retrieves snippets from the use case indexed snippet database 103. In one example, the snippet retriever 1010 may retrieve a snippet based on the retrieved URL, according to the offline index table. In another example, the snippet retriever 1010 may retrieve a snippet based on the determined entity type and/or use case, according to the offline index table. In one embodiment, the snippet retriever 1010 may also retrieve confidence scores associated with the retrieved snippets. The snippet retriever 1010 may send the snippets to the snippet ranking unit 1012, maybe with associated confidence scores.

The snippet ranking unit 1012 in this example may rank the snippets retrieved by the snippet retriever 1010, e.g. based on their respective confidence scores. If the snippet retriever 1010 does not send the confidence scores, the snippet ranking unit 1012 may retrieve the confidence scores based on the index table. When a query matches multiple use cases, the snippet ranking unit 1012 may also consider a degree of match for each use case, in addition to the confidence score for the snippet. For example, snippet A with confidence score 0.9 is associated with use case X having a matching score 0.6 regarding the query, while snippet B with confidence score 0.75 is associated with use case Y having a matching score 0.9 regarding the query. In that situation, the snippet ranking unit 1012 may rank the snippet B higher than snippet A, due to its higher product of the confidence score and the use case matching score. The snippet ranking unit 1012 may generate a list of ranked snippets and send the list to the search result provider 1014.

The search result provider 1014 in this example provides the ranked snippets to the user as a response to the search request. The search result provider 1014 may also generate a search result based on the snippets. For example, the search result provider 1014 may provide a search result to be presented in a search result page which includes URLs representing web pages related to the query, with a snippet representative of the corresponding web page beside each URL. The search result page may include both the URLs and snippets retrieved based on the offline index table disclosed above and URLs and snippets generated by keyword matching or based on knowledge graphs. In one example, the URLs and snippets retrieved based on the use case index disclosed above may be presented with a higher priority, e.g. on top of the search result page, or with special user interface parameters like special color, font, line space, etc.

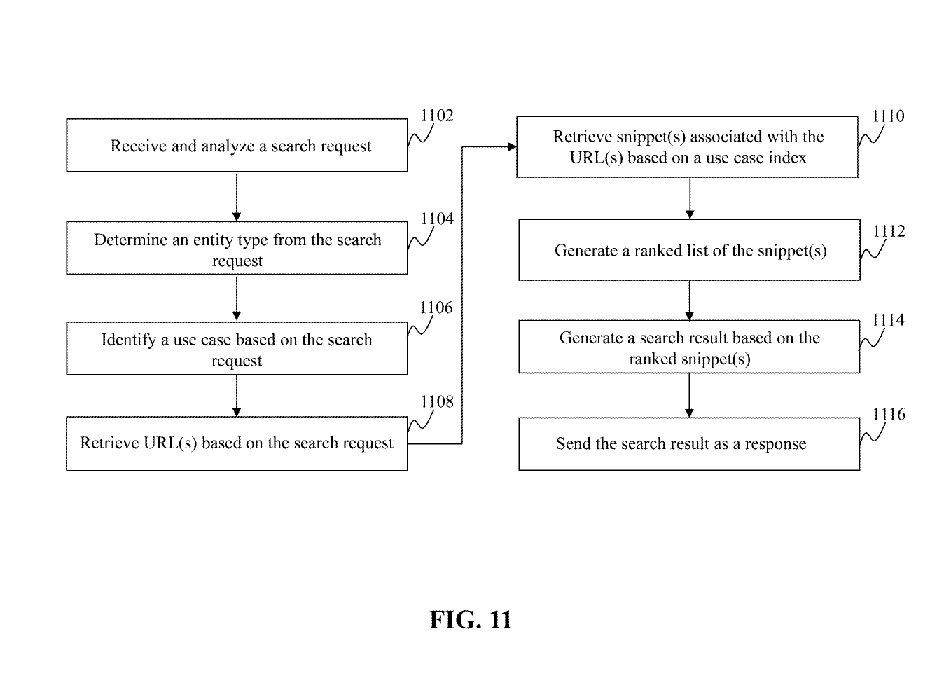

FIG. 11 is a flowchart of an exemplary process performed by the search engine 102, according to an embodiment of the present teaching. At 1102, a search request is received and analyzed. At 1104, an entity type is determined from the search request. At 1106, a use case is determined based on the search request. At 1108, one or more URLs are retrieved based on the search request.

At 1110, one or more snippets are retrieved based on the associated URLs, the associated use cases, and/or based on an offline index. At 1112, the snippets are ranked, e.g. based on their respective confidence scores. At 1114, a search result is generated based on the ranked snippets. At 1116, the search result is sent as a response.

In one embodiment, the search engine 102 can directly retrieve the relevant snippets once the entity and the use case of the query are determined. This is because the snippet is indexed by entity and use case in the use case indexed snippet database 103. Then based on some ranking/selection model, the top snippets can be used to satisfy the use case, i.e., the system can provide a direct answer to the query provided that the returned snippets have the proper structured information as the answer to the query, in addition to the usual URL search results. In other scenarios, the system may generate additional features for the usual search result and personalization algorithms to improve better quality.

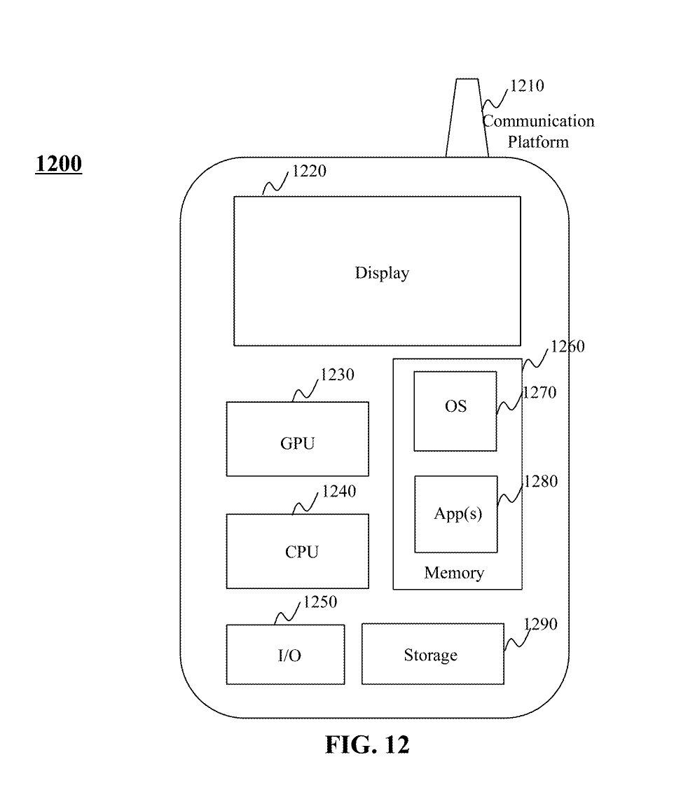

FIG. 12 depicts the architecture of a mobile device which can be used to realize a specialized system implementing the present teaching. In this example, the user device on which content and search result are presented and interacted—with is a mobile device 1200, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1200 in this example includes one or more central processing units (CPUs) 1240, one or more graphic processing units (GPUs) 1230, a display 1220, a memory 1260, a communication platform 1210, such as a wireless communication module, storage 1290, and one or more input/output (I/O) devices 1250. Any other suitable component, including but not limited to a system bus or a controller (not shown), may also be included in the mobile device 1200. As shown in FIG. 12, a mobile operating system 1270, e.g., iOS, Android, Windows Phone, etc., and one or more applications 1280 may be loaded into the memory 1260 from the storage 1290 in order to be executed by the CPU 1240. The applications 1280 may include a browser or any other suitable mobile apps for search result generation and presentation with snippets on the mobile device 1200. User interactions with the content in a search result may be achieved via the I/O devices 1250 and provided to the search engine 102 and/or the indexed snippet generation engine 104 and/or other components of systems 100 and 200, e.g., via the network 110.

To implement various modules, units, and their functionalities described in the present disclosure, computer hardware platforms may be used as the hardware platform(s) for one or more of the elements described herein (e.g., the search engine 102 and/or the indexed snippet generation engine 104 and/or other components of systems 100 and 100 described with respect to FIGS. 1-11). The hardware elements, operating systems and programming languages of such computers are conventional in nature, and it is presumed that those skilled in the art are adequately familiar therewith to adapt those technologies to generate and retrieve use case indexed snippets for providing a search result as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

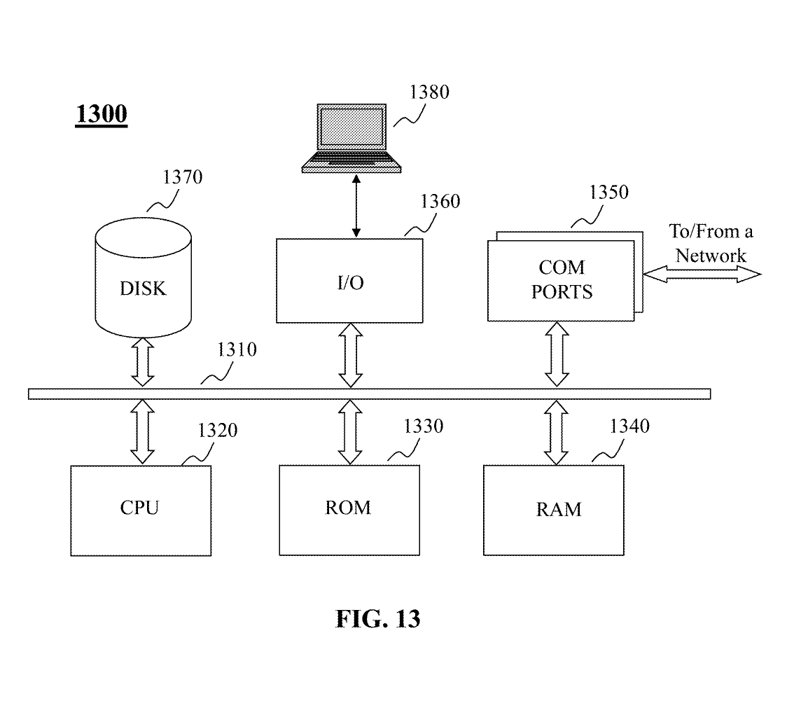

FIG. 13 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1300 may be used to implement any component of the snippet generation and retrieval techniques, as described herein. For example, the indexed snippet generation engine 104, etc., may be implemented on a computer such as computer 1300, via its hardware, software program, firmware, or a combination thereof. Although only one such computer is shown, for convenience, the computer functions relating to generating an offline index based on use case and retrieving snippet based on the offline index as described herein may be implemented in a distributed fashion on a number of similar platforms, to distribute the processing load.

The computer 1300, for example, includes COM ports 1350 connected to and from a network connected thereto to facilitate data communications. The computer 1300 also includes a central processing unit (CPU) 1320, in the form of one or more processors, for executing program instructions. The exemplary computer platform includes an internal communication bus 1310, program storage and data storage of different forms, e.g., disk 1370, read only memory (ROM) 1330, or random access memory (RAM) 1340, for various data files to be processed and/or communicated by the computer, as well as possibly program instructions to be executed by the CPU. The computer 1300 also includes an I/O component 1360, supporting input/output flows between the computer and other components therein such as user interface elements 1380. The computer 1300 may also receive programming and data via network communications.

Hence, aspects of the methods of snippet generation and retrieval, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other snippet generator into the hardware platform(s) of a computing environment or other system implementing a computing environment or similar functionalities in connection with snippet generation and retrieval. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the snippet generation and retrieval as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for generating a snippet, the method comprising:
obtaining a document;
identifying one or more keywords in the document;
determining one or more topics based on the one or more keywords, wherein each of the one or more topics is related to at least one of the one or more keywords residing in one or more portions of the document; and
generating a snippet for each of the portions associated with a corresponding topic based on content in the portion of the document.

2. The method of claim 1, further comprising generating an index for each of the snippets based on the corresponding topic associated with the snippet.

3. The method of claim 1, wherein the determining comprises:
matching each of the one or more keywords with the one or more topics;
generating a score for each of the one or more topics based on the matching; and
ranking the one or more topics based on their respective scores.

4. The method of claim 1, wherein the generating comprises:
obtaining one or more parameters associated with the corresponding topic;
extracting information from the portion of the document according to the one or more parameters; and
generating the snippet based on the extracted information.

5. The method of claim 1, further comprising storing the snippet associated with the corresponding topic and the portion of the document in a database.

6. The method of claim 1, wherein the snippet is also associated with at least one of:
the document;
a URL (uniform resource locator) associated with the document;
the portion of the document;
one or more parameters representing a structure of the snippet; and
a confidence score indicating how likely the snippet can represent the portion of the document.

7. A method, implemented on a machine having at least one processor, storage, and a communication platform connected to a network for providing a search result, the method comprising:
receiving a query;
identifying one or more keywords from the query;
determining one or more topics associated with the query based on the one or more keywords;
retrieving one or more snippets based on the one or more topics, wherein each of the snippets corresponds to a portion of a corresponding document that is related to a topic associated with the snippet; and
providing the one or more snippets in response to the query.

8. The method of claim 7, further comprising providing a representation of a corresponding document associated with each of the one or more snippets in response to the query.

9. The method of claim 7, wherein the determining comprises:
matching each of the one or more keywords with the one or more topics;
generating a score for each of the one or more topics based on the matching; and
ranking the one or more topics based on their respective scores.

10. The method of claim 7, wherein the providing comprises:
ranking the one or more snippets; and
providing the ranked one or more snippets in response to the query.

11. The method of claim 7, wherein at least one of the one or more snippets is associated with at least one of:
the corresponding document;
a URL associated with the corresponding document;
the portion of the corresponding document;
one or more parameters representing a structure of the snippet; and
a confidence score indicating how likely the snippet can represent the portion of the corresponding document.

12. A system having at least one processor, storage, and a communication platform connected to a network for generating a snippet, comprising:
a document obtaining unit configured for obtaining a document;
an entity detector configured for identifying one or more keywords in the document;
a use case matching unit configured for determining one or more topics based on the one or more keywords, wherein each of the one or more topics is related to at least one of the one or more keywords residing in one or more portions of the document;
an indexed snippet generator configured for generating a snippet for each of the portions associated with a corresponding topic based on content in the portion of the document.

13. The system of claim 12, wherein the indexed snippet generator comprises an index generator configured for generating an index for each of the snippets based on the corresponding topic associated with the snippet.

14. The system of claim 12, wherein the use case matching unit is further configured for:
matching each of the one or more keywords with the one or more topics; and
generating a score for each of the one or more topics based on the matching, wherein the one or more topics are ranked based on their respective scores.

15. The system of claim 12, wherein the indexed snippet generator comprises:
a snippet parameter determiner configured for obtaining one or more parameters associated with the corresponding topic;
a structured text extractor configured for extracting information from the portion of the document according to the one or more parameters; and
a snippet generator/updater configured for generating the snippet based on the extracted information.

16. The system of claim 12, wherein the snippet is also associated with at least one of:
the document;
a URL associated with the document;
the portion of the document;
one or more parameters representing a structure of the snippet; and
a confidence score indicating how likely the snippet can represent the portion of the document.

17. A system having at least one processor, storage, and a communication platform connected to a network for providing a search result, comprising:
a search request analyzer configured for receiving a query;
an entity type identifier configured for identifying one or more keywords from the query;
a use case determiner configured for determining one or more topics associated with the query based on the one or more keywords;
a snippet retriever configured for retrieving one or more snippets based on the one or more topics, wherein each of the snippets corresponds to a portion of a corresponding document that is related to a topic associated with the snippet; and
a search result provider configured for providing the one or more snippets in response to the query.

18. The system of claim 17, wherein the search result provider is further configured for providing a representation of a corresponding document associated with each of the one or more snippets in response to the query.

19. The system of claim 17, wherein the use case determiner is further configured for:
matching each of the one or more keywords with the one or more topics;
generating a score for each of the one or more topics based on the matching; and
ranking the one or more topics based on their respective scores.

20. The system of claim 17, further comprising a snippet ranking unit configured for ranking the one or more snippets.

21. The system of claim 17, wherein at least one of the one or more snippets is associated with at least one of:
the corresponding document;
a URL associated with the corresponding document;
the portion of the corresponding document;
one or more parameters representing a structure of the snippet; and
a confidence score indicating how likely the snippet can represent the portion of the corresponding document.

22. A machine-readable, non-transitory and tangible medium having data recorded thereon for generating a snippet, the medium, when read by the machine, causes the machine to perform the following:
obtaining a document;
identifying one or more keywords in the document;
determining one or more topics based on the one or more keywords, wherein each of the one or more topics is related to at least one of the one or more keywords residing in one or more portions of the document; and
generating a snippet for each of the portions associated with a corresponding topic based on content in the portion of the document.

23. A machine-readable, non-transitory and tangible medium having data recorded thereon for providing a search result, the medium, when read by the machine, causes the machine to perform the following:
receiving a query;
identifying one or more keywords from the query;
determining one or more topics associated with the query based on the one or more keywords;
retrieving one or more snippets based on the one or more topics, wherein each of the snippets corresponds to a portion of a corresponding document that is related to a topic associated with the snippet; and
providing the one or more snippets in response to the query.
